(19) United States
(12) Patent Application Publication
(10) Pub. No.: US 2011/0310357 A1
(43) Pub. Date: Dec. 22, 2011

(54) MULTIPLE RATE PROJECTOR

(76) Inventor: KUO-CHING CHIANG, Linkou Township (TW)

(21) Appl. No.: 13/214,496

(22) Filed: Aug. 22, 2011

Related U.S. Application Data
(63) Continuation-in-part of application No. 12/711,366, filed on Feb. 24, 2010.
Application No. 12/711,366 is a continuation-in-part of application No. 11/701,158, filed on Jan. 31, 2007.
Application No. 11/701,158 is a continuation-in-part of application No. 11/783,551, filed on Apr. 10, 2007, now Pat. No. 7,874,486.
Application No. 11/701,158 is a continuation of application No. 10/989,622, filed on Nov. 15, 2004, now Pat. No. 7,178,735.
Application No. 11/783,551 is a continuation-in-part of application No. 10/989,622, filed on Nov. 15, 2004, now Pat. No. 7,178,735.
Application No. 12/711,366 is a continuation-in-part of application No. 10/989,622, filed on Nov. 15, 2004, now Pat. No. 7,178,735.

(51) Int. Cl. G03B 21/00

(52) U.S. Cl. 353/33; 353/31

(57) ABSTRACT

A multiple rate projector comprises at least three different color illuminations to illuminate a pre-determined light, respectively. A color control module is coupled to the at least three different color illuminations to switch the at least three different color illuminations on, respectively to allow turn-on times of two of the at least three different color illuminations are not overlapped, or the turn-on times of the two of the at least three different color illuminations are overlapped with half cycle, longer or short than half cycle of on cycle of each the at least three different color illuminations; and a two-dimension reflector reflects illumination from the at least three different color illuminations to a location.

The application is a continuation in part application of Ser. No. 12/711,366, filed on Feb. 24, 2010.

### FIELD OF THE INVENTION

The present invention relates generally to a projector, and more particularly to a multiple rate projector

### BACKGROUND OF THE INVENTION

Cellular communications systems typically include multiple base stations for communicating with mobile stations in various geographical transmission areas. Each base station provides an interface between the mobile station and a telecommunications network. Mobile telephone systems are in use or being developed in which the geographic coverage area of the system is divided into smaller separate cells, it communicates with the network via a fixed station located in the cell. Mobile telephones belonging to the system are free to travel from one cell to another. When a subscriber within the same system or within an external system wishes to call a mobile subscriber within this system, the network must have information on the actual location of the mobile telephone.

Recently, the price of cellular telephone has been greatly reduced and become affordable to lots of people. It is common that a person owns more than one cellular phone. Some people even replace their cellular telephones as often as they replace their clothes or hairstyle. The cellular manufactures have to release new models with different appearances, function and styles more frequently so as to attract the attention of the buyer and occupy a favorable marketing share. Furthermore, the conventional projector employ white light lamp as a light source, therefore, at least two reflector lens and at least three light-split lens are required to split the white light into three colors (red, green and blue). The optical lens set is expensive. The mechanism of the optical system is too complicated and the size can not be reduced. Further, the lamp source will generate heat with high temperature.

### SUMMARY OF THE INVENTION

The object of the present invention is to provide a projector with light switching rate is multiple to image signal frame rate.

The portable device comprises a control IC and a projection display module for the data projection. The portable communication device with embedded projector includes a RF module embedded in the portable communication device for wireless vocal communication; a built-in display embedded in the portable communication device for display; wherein the portable communication device comprises: a control IC; red, green and blue illuminations coupled to the control IC to illuminate a pre-determined light, respectively; a light guiding device coupled to the red, green and blue illuminations, wherein the red, green and blue illuminations respectively positioned corresponding to the light guiding device which is introduced to guide the illuminations from the red, green and blue illuminations to reflector; and two-dimension reflector coupled to the light guiding device to reflect a pre-determined color illumination on a pre-determined location defined by the control IC to enlarge projection image.

The multiple rate projector comprises at least three different color illuminations to illuminate a pre-determined light, respectively; a color control module coupled to the at least three different color illuminations to switch the at least three different color illuminations; wherein a switching rate of the at least three different color illuminations is multiple time to an image signal frame rate; and a two-dimension reflector reflects illumination from the at least three different color illuminations to a location.

A multiple rate projector comprises at least three different color illuminations to illuminate a pre-determined light, respectively; a color control module coupled to the at least three different color illuminations to allow the at least three different color illuminations be switched on, respectively to allow turn-on times of two of the at least three different color illuminations are not overlapped, or the turn-on times of the two of the at least three different color illuminations are overlapped with half cycle, longer or short than half cycle of on cycle of each the at least three different color illuminations; and a two-dimension reflector reflects illumination from the at least three different color illuminations to a location. A light guiding device is provided to allow the at least three different color illuminations located three sides of the light guiding device. The light guiding device includes X cube, X plate or prism.

A further aspect of the present invention is to disclose a portable device comprising a control IC imbedded in the portable device; a RF module coupled to the control IC for wireless communication; a display, memory and an input unit coupled to the control IC; and a remote control module coupled to said central control IC to control lock or a device by the key code coded in the memory.

The present invention can be integrated into a portable device. In order to achieve the object of the present invention, a portable device comprises a control IC imbedded in the portable device; a RF module coupled to the control IC for wireless communication; a display, memory and an input unit coupled to the control IC; and an illumination source embedded in the portable device for acting as pointer or flashlight. The illumination source includes a laser component. Wherein the illumination source include a lamp (or LED) and a reflector position in accordance with the lamp to reflect light generated by the lamp.

### BRIEF DESCRIPTION OF THE DRAWINGS

FIG. 1 shows a diagram of a cellular terminal according to the present invention.

FIG. 2 and FIG. 3 show a diagram of a projection display module according to the present invention.

FIGS. 4 to 6A, 6B show diagrams of a projection display module according to the present invention.

FIG. 7A to 7D show timing diagram of image signal frame and illuminations according to the present invention.

FIG. 7-8 show diagrams of a media player and digital camera with the projection display module according to the present invention.

FIG. 9 shows a diagram of a notebook with the projection display module according to the present invention.

### DETAILED DESCRIPTION

The present invention relates generally to a multiple rate projector and multi-function portable terminal. The portable terminal includes but not limited to cellular phone, PDA (personal digital assistant), notebook, computer, tablet smart phone, digital camera, media player and notebook and the equivalent thereof.

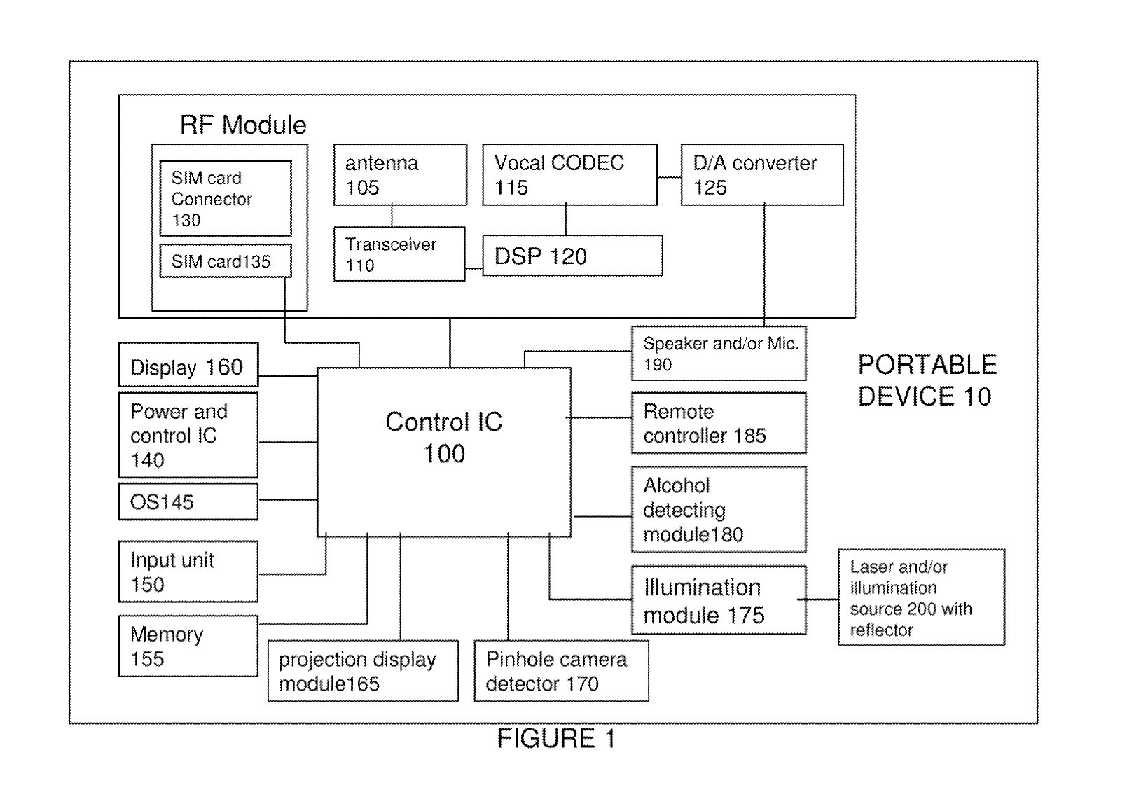

FIG. 1 shows a block diagram of a portable terminal with SIM card connector 130 to carry the SIM card 135, it is well know in the art, the SIM card is not necessary for some other type of cellular such as PHS system. The diagram is used for illustrating and not used for limiting the scope of the present invention. The portable terminal or device 10 included a RF module. As know in the art, the RF module includes antenna 105. This antenna 105 is connected to a transceiver 110, which is used to receive and transmit signal. AS know, the RF module further includes CODEC 115, DSP 120 and A/D converter as well. Due to the RF module is not the feature of the present invention, therefore, the detailed description is omitted. The present invention includes a central control IC 100, an input unit 150, a build-in display 160, OS 145, power and control IC 140 and memory 155 including a ROM program memory, a RAM memory and a nonvolatile FLASH memory. The RF module may perform the function of signal transmitting and receiving, frequency synthesizing, base-band processing and digital signal processing. The SIM card hardware interface is used for receiving a SIM card. Finally, the signal is send to the final actuators, i.e. a loudspeaker and a microphone 190.

The present invention includes one or more following module that is not disclosed by the current cellular terminal. It should be noted that the additional module can be implanted along or combination depending on the necessary.

A pinhole camera detector 170 indicates the addition of a device, which is apt to wireless or wired signal. The pinhole camera detector is sensitive to the transmittance frequency, for example, from the 300 MHz to 2.5 GHz, and is coupled to the control IC 100. The detector also includes a switch coupled to pinhole camera detector to active the detector. As known, the pinhole video camera includes a printed circuit board, a charged coupled device (hereinafter referred to as “CCD”), memory means for storing a single frame image which is generated by image signal from the CCD and a signal converting means, a connector with wires to connect the aforementioned circuits to power source and the displayer. A conical convex lens is accommodated to have an apical angle and the apex is fixed so as to face the pinhole. The pinhole camera detector 120 is available to scan and detect the operation frequency while the pinhole camera is in function. The so-called spy camera could also be detected by the pinhole camera detector 120 as well. The scanned result can be send to the display 160 and/or the loudspeaker and a microphone 190, thereby sending an alarm signal.

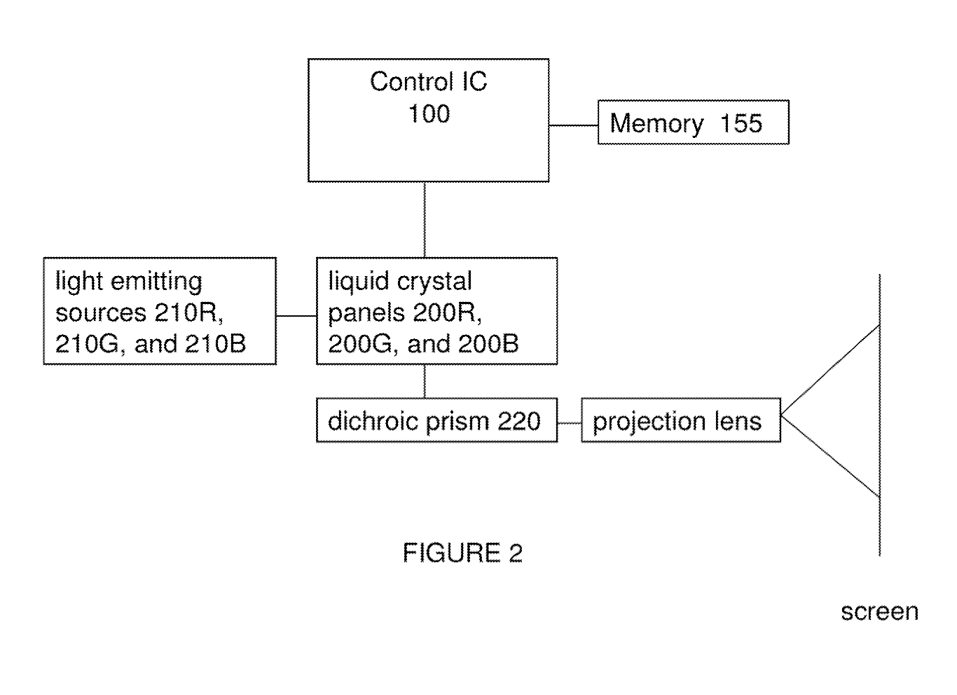

Moreover, the portable terminal according to the present invention shown in FIG. 1 has another function module. An embodiment is now described with reference to FIG. 2. A projection display module 165 is coupled to the control IC 100. One type of such a projection display module 165 that is known is the liquid crystal projector wherewith images on a liquid crystal panel are enlarged and projected by a projection lens onto a reflective screen and thus displayed. The liquid crystal projection display module comprises a light source lamp unit inside a shell of the device. Electrical discharge lamps such as metal halide lamps, or halogen lamps, could be used in the light source lamp unit. The light emitted from this light source lamp unit is guided via a mirror to dichroic mirrors, whereby it is separated into red light, green light, and blue light. The images displayed on the three liquid crystal panels, respectively, are illuminated by their respective colors, and this light is combined by a dichroic prism.

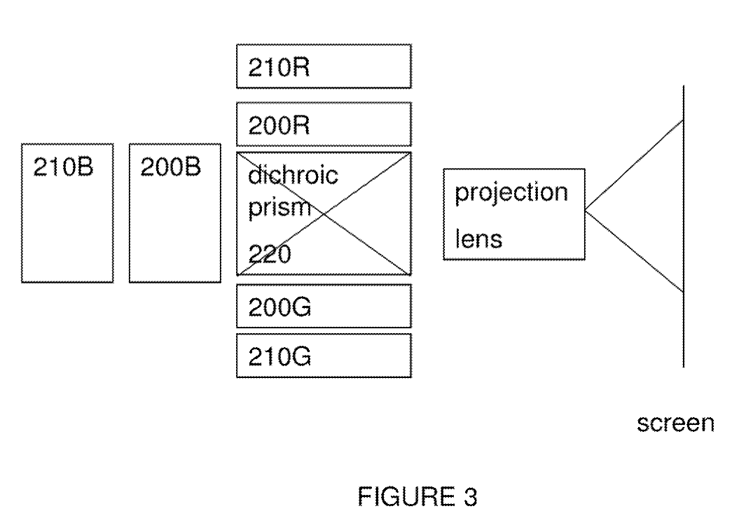

In preferable embodiment, please refer to FIG. 3, the liquid crystal projector comprises three liquid crystal panels 200R, 200G, and 200B that perform image displays in red, green, and blue, respectively. Preferably, panel-form light emitting sources 210R, 210G, and 210B is employed and positioned in correspondence with the liquid crystal panels, respectively. In one embodiment, the light emitting sources 210R, 210G, and 210B are organic EL (electroluminescence) elements. These organic EL elements are electric-field light emitting thin films that capable of emission of red, green, and blue light. The EL elements are formed behind and adjacent to the liquid crystal panels 200R, 200G, and 200B, respectively. The liquid crystal panels 200R, 200G, and 200B and the light sources 210R, 210G, and 210B are positioned on the light-incidence side of the side surfaces of the dichroic prism 220 for each display color combination. The projection lens 230 could be made up of a plurality of lenses. Thus, the data or file stored in the memory of the device can be projected on a screen or wall. It allows the user to project the image, game or file on an external screen. The EL element is small, flat form, light weight, therefore, it allows the small projection to be integrated in the portable device.

A further aspect of the present invention is that the device 10 also includes remote control module 185. The remote control module 185 maybe used to control lock or device by the key code coded in the remote control module 185. The remote controller is also a mature technology. Remote controllers for electrical and electronic appliances are well known, and are widely used. In one example, the remote control module 185 applies infrared rays for transmission, and each company provides its appliances and remote controllers with its specific protocol of communication. An example of the remote control module 185 is provided with an interface for downloading the relevant information into the remote control module 185 from an external source. In one embodiment of remote controller is provided with an infrared transmitter for sending remote controlling signals to the appliance. The remote controller is provided with a RAM or ROM, or EPROM, or EEPROM internal database (memory 155) to which set-up information regarding the key-map and signal format of at least one apparatus to be controlled is entered. Such information can be commonly provided to the internal database from various sources, such as from a smart card, from an Internet database, from a plugged-in card, etc. The database in the appliance contains set-up data that can be transmitted by transmitter to the remote control module 185 providing it all the information it needs in order to control the appliance. The present invention uses the RF module to download the key code from database through network.

Another aspect of the present invention is that the portable device 10 also includes an alcohol detecting module 180. The alcohol ingredients detecting module 180 is provided and coupled to the control IC 100 to detect the alcohol ingredients from one's breath, for example, the module is capable of detecting alcohol content. The alcohol detecting module 180 is sensitive to the aforementioned alcohol content. If the bonding is detected, the signal will be send from the alcohol detecting module 180 to the control IC 100 for determine the level of the alcohol ingredients. Then, the result will be send to the display 160. U.S. Pat. No. 5,907,407 had disclosed various methods to detecting the alcohol. U.S. Pat. No. 4,809,810 disclosed a system both apparatus and method, for analyzing a breath sample.

Further, an illumination module 175 is also employed by the present invention. The portable device could be used as a laser pointer if the illumination module 175 includes a laser component 200. A switch can be provided to active the laser. In another embodiment, the illumination module 175 includes a light source to allow the portable device to be used as the flashlight. Especially, one may turn on the illumination module 175 in dark environment such as in a theater. The illumination module 175 could be coupled to the control IC 100 or implanted with an independent control IC. The illumination source includes a laser component. Wherein the illumination source include a lamp (or LED) and a reflector position in accordance with the lamp to reflect light generated by the lamp. The aforementioned laser devices or LED could be user for the projector as the aforementioned panel-form light sources as well.

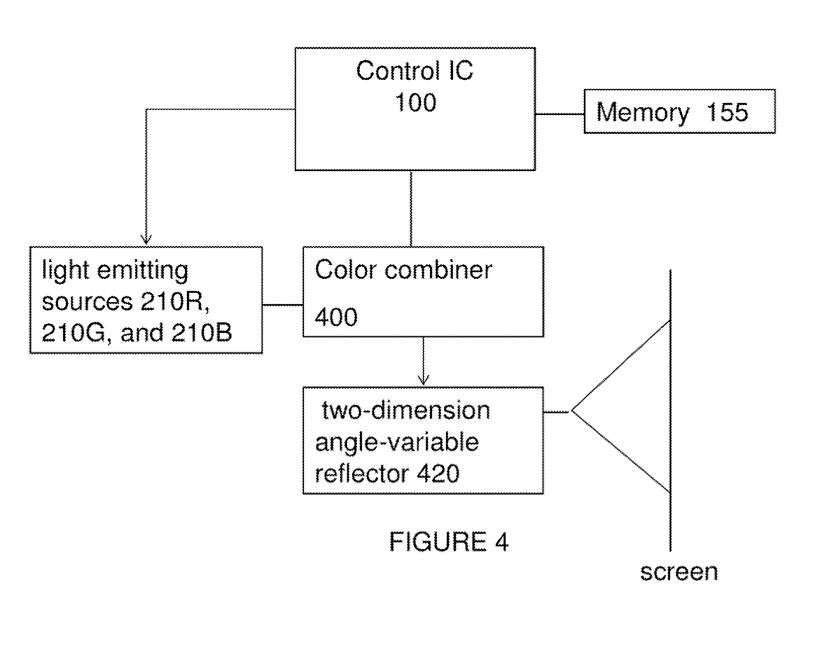

An embodiment is now described with reference to FIG. 4. Pluralities of illuminations 210R, 210G, 210B are coupled to the control IC 100. The control IC will sent a image control signal to the pluralities of illuminations 210R, 210G, 210B, respectively. The pluralities of illuminations 210R, 210G, 210B are all independent light sources, such as LED, OLED or Laser. The images will be enlarged and projected by two-dimension reflector onto a reflective screen and thus displayed. A color combiner (or illuminator combiner) 400 will receive the illumination from each of the pluralities of illuminations 210R, 210G, 210B, thereby constructing a demanded color which is determined by the control IC 100. The color combiner (or illuminator combiner) 400 can mix any color via the R, G, B illumination sources at any timing controlled by the control IC 100. A two-dimension angle-variable reflector 420 is coupled to the color combiner (or illuminator combiner) 400 to reflect the combined illumination to a pre-determined location on the screen. The two-dimension angle-variable reflector 420 may change the angle between the normal line of the screen and the reflected beam. Preferably, the two-dimension reflector 420 is made by thin membrane which can reflect illumination along the X and Y axis to show the image pixel-by pixel. It can be made by digital mirror technology or micro electro mechanical systems. The illuminations includes a laser, LED, or OLED to emit a laser beam to the two dimension reflector for horizontally moving the laser beam at a first sweep frequency along X-axis, and vertically moving the laser beam up or down along Y-axis. The control IC is operative for controlling two-dimension reflector to insure the pixel of the image can be reflected to a demanded location. A driver of the two-dimension reflector drives the angle of the two-dimension reflector. The driver horizontally sweeps X-direction to form a horizontal scan line from one point, then the drive adjusts the angle to move scan line to next vertical position, followed by sweeping another X-direction to form a second horizontal scan line along the X-direction to form a second scan line. The formation of successive scan lines proceeds in the same manner. The whole image can be scanned by one two dimension reflector and can be made by digital mirror technology or micro electro mechanical systems. The projection image can be displayed by the two dimension reflector.

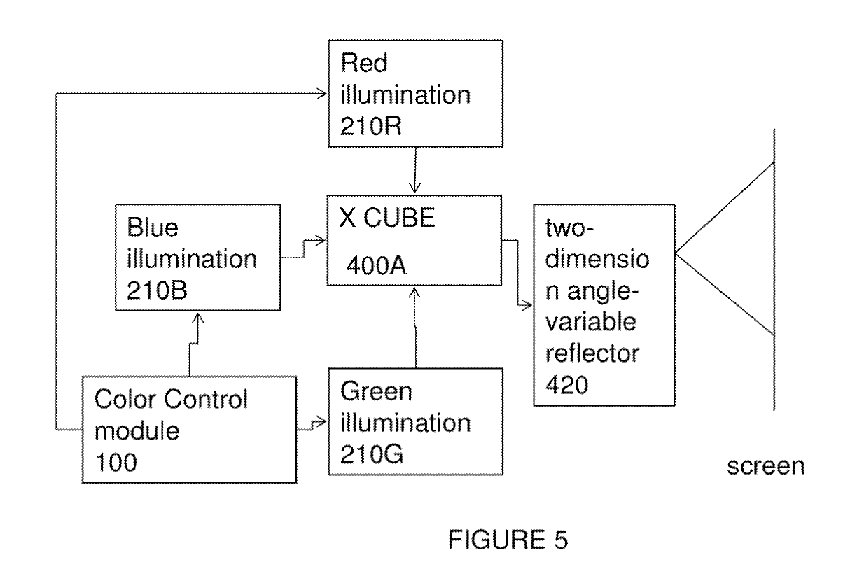

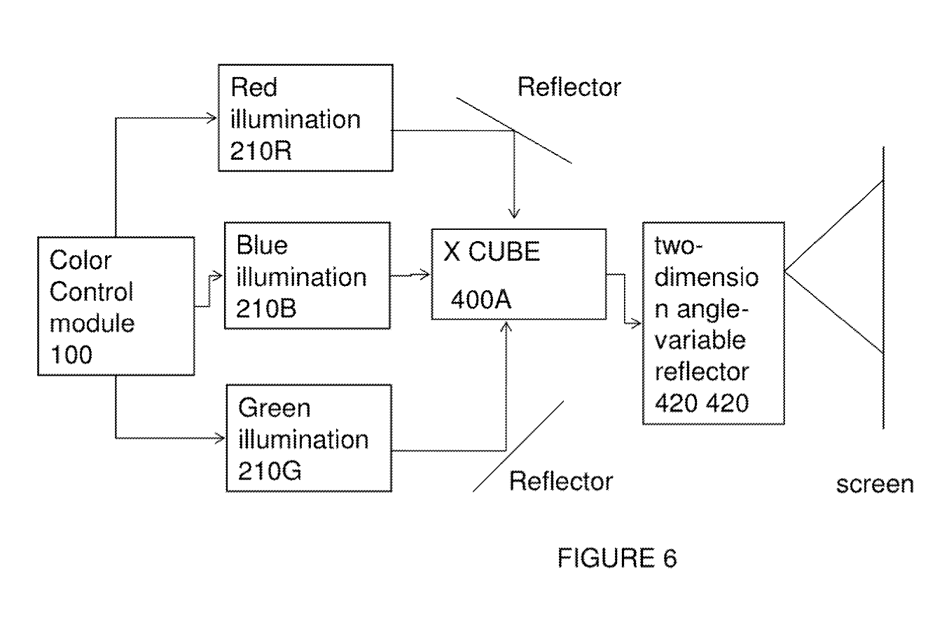

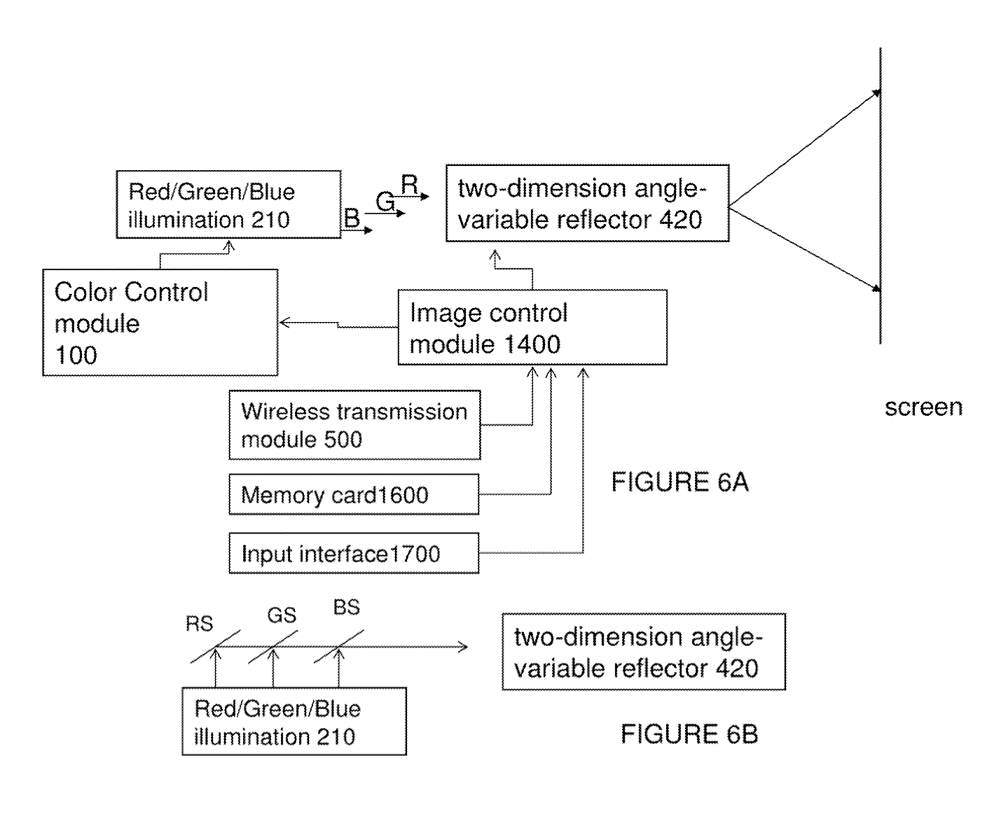

In one embodiment, please refer to FIG. 5, light emitting (illumination) sources 210R, 210G, and 210B is employed and positioned in correspondence with the X cube or prism 400A, respectively. The light emitting sources 210R, 210G and 210B are set at the three sides of the X cube 400A. In one embodiment, the light emitting sources 210R, 210G, and 210B are organic EL (electroluminescence) elements, OLED, LED or Laser. These organic EL elements are electric-field light emitting thin films that capable of emission of red, green, and blue light. The illumination sources are formed adjacent to the X cube or prism 400A, respectively. The light sources 210R, 210G, and 210B are positioned on the three sides of the X cube or prism 400A, therefore, the optical path between each illumination sources and the reflector is equal. Thus, the data or file stored in the memory of the device can be projected on a screen or wall. It allows the user to project the image, game or file on an external screen. The OLED or EL element is small, flat form, light weight, therefore, it allows the small projection to be integrated in the portable device. FIG. 6 shows that the light emitting sources 210R, 210G, and 210B are reflected by a reflector, and thereby projecting by the two-dimension reflector 420.

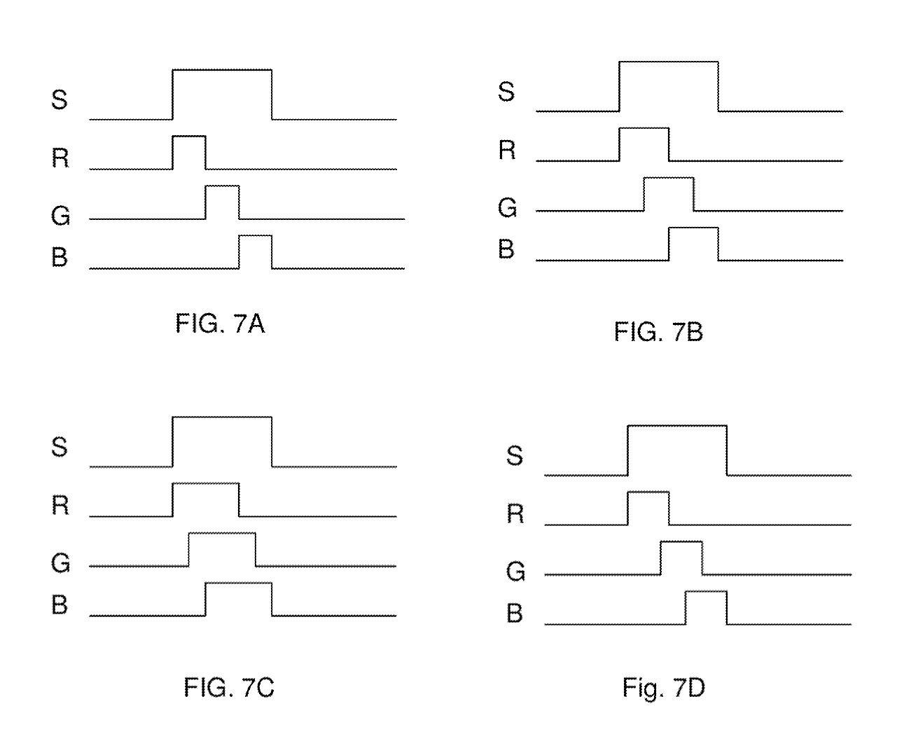

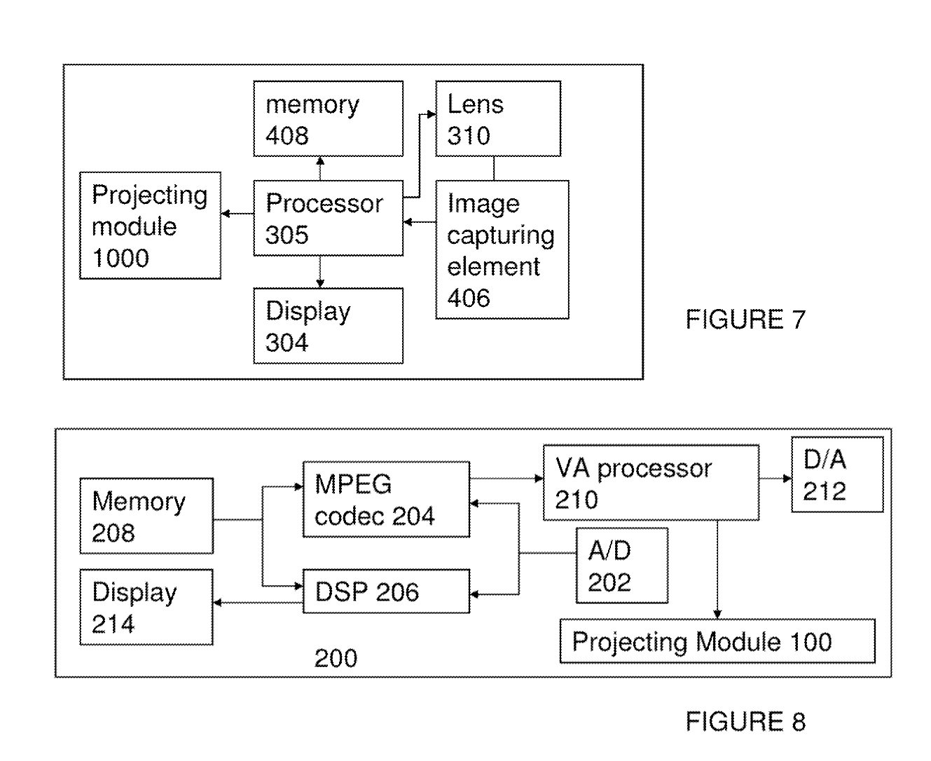

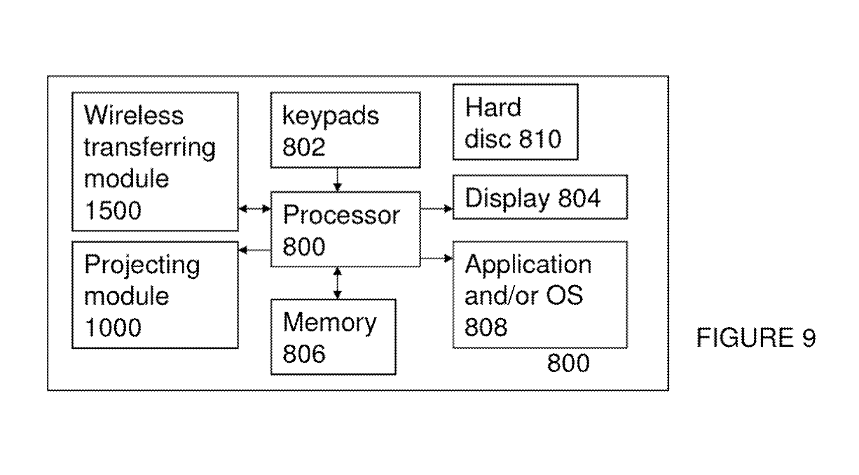

Further, referring to FIG. 7, the device includes a main body having a process 402; a display 404 formed on the main body and coupled to the processor 402; an image capture element 406 formed within the main body and coupled to the processor 402; a memory 408 coupled to the processor; a lens mechanism 310 formed on the main body, coupled to the processor 402 and corresponding to the image capture element 406; the projecting module 1000 is coupled processor of the portable device so as to project the captured image on a screen. The projecting module 1000 is disclosed from above preferred embodiment alone or combination.

If the projecting module 1000 is employed for medium player such as MP3 player, MP4 player, the player includes an analog/digital (A/D) converter 202 for converting analog audio signals into digital audio signals. The analog audio signals can come from an audio source coupled to player 200. A digital signal processor (DSP) 204 or an audio and/or video driving module 206, for instance MP3, MP4 codec, are coupled to A/D converter 202 to receive the digital audio signals. In one embodiment, MP3 or MP4 codec 206 executes a firmware that includes a MPEG audio layer (e.g., MP3, MP2, or both) codec or video codec (e.g., MP4), and DSP 204 executes a firmware that includes a different type of audio codec (e.g., WMA, ACC, or both). In one embodiment, the firmware for DSP 204 also includes a video codec for encoding and decoding videos (e.g., MPEG-4 V1/V2/V3, DivX 3.11/4.0/5.0, Xvid, AVI/ASF, or any combination thereof). MP3 (or MP4) codec 206 and DSP 204 are coupled to a nonvolatile memory 208 that stores the compressed audio data. The user can select an audio file from nonvolatile memory 208. DSPs 204 and 206 are coupled to an audio processor 210, which processes the digital audio signals according to default settings or user instructions. Audio processor 210 is coupled to a digital/analog (D/A) converter 212, which converts the digital audio signals into analog audio signals for the user. A display 214 is coupled to the DSP 206. The projecting module 1000 is disclosed from above preferred embodiment alone or combination.

As shown in FIG. 8, wherein the projecting module 1000 can be integrated into the portable computer system comprises: a processor 800 formed within the portable device; a keypad 802 formed on the portable device; a display 804 coupled the processor; a memory 806 coupled to said processor 800. The device further includes an application and/or OS 808 and hard disc 810 coupled to the processor. It further includes the WLAN module 1500 and the projecting module 1000. Similarity, the present invention can be used in electronic book.

An embodiment is now described with reference to FIG. 6A. The optical configuration of FIG. 5-6 may be employed and integrated into FIG. 6A. The illumination 210 is coupled to the control IC 100. The control IC will transmit an image color control signal to the pluralities of illuminations 210R, 210G, 210B, respectively. The illumination 210 includes three color independent light sources, namely, red, green and blue light sources, such as LED, OLED or Laser. The images will be enlarged and projected by two-dimension reflector onto a reflective screen and thus displayed. It should be noted that the color combiner mentioned above is omitted in the embodiment to shrink the size of the device. The R, G, B light sources of the illumination 210 will independently emit light by sequence based on the color instruction from the color control IC 100 which is coupled to the image signal control module 1400. The image signal control module 1400 instructs the color of specific pixel or location. Then, the color control IC 100 will instruct the R, G, B light sources of the illumination 210 to emit light independently with different power to obtain the determined color for a specific location. The three light beams are emitted at different time and arrive at the reflector 420 with a predetermined angle in sequence. Then, the reflector 420 will reflect the three beams to the predetermined location in sequence. If the color is green, only the green light source will be emitted, accordingly. Based on the color mixture principle, any color can be achieved by mixture the three colors. During the persistence of vision phenomena, the eyes will detect the color image even the light beams arrive at the location of the screen at different times. Therefore, the color is not combined by the combiner. The illumination from each of the pluralities of illuminations 210R, 210G, 210B is emitted in sequence, thereby constructing a demanded color which is determined by the control IC 100. A two-dimension angle-variable reflector 420 is coupled to the R/G/B light sources to reflect the non-combined illumination to a pre-determined location on the screen. The two-dimension angle-variable reflector 420 may change the angle between the normal line of the screen and the reflected beam. Preferably, the two-dimension reflector 420 is made by thin membrane which can reflect illumination along the X and Y axis to show the image pixel-by pixel. It can be made by digital mirror technology or micro electro mechanical systems. The illuminations includes a laser, LED, or OLED to emit a light beam to the two dimension reflector for horizontally moving the laser beam at a first sweep frequency along X-axis, and vertically moving the laser beam up or down along Y-axis. The control IC is operative for controlling two-dimension reflector to insure the pixel of the image can be reflected to a demanded location. A driver of the two-dimension reflector drives the angle of the two-dimension reflector. The driver horizontally sweeps X-direction to form a horizontal scan line from one point, then the drive adjusts the angle to move scan line to next vertical position, followed by sweeping another X-direction to form a second horizontal scan line along the X-direction to form a second scan line. The formation of successive scan lines proceeds in the same manner. The whole image can be scanned by one two dimension reflector and can be made by digital mirror technology or micro electro mechanical systems. The projection image can be displayed by the two dimension reflector.

Please refer to FIG. 6B, splitters RS, BS, GS is aligned to the reflector 420 and the three R/G/B light sources aim at the splitters respectively. It will let the incident light from one direction toward a certain direction and allow incident light pass through from another direction under the scheme of color sequence. The three different independent lights may be switch with a first frequency which is triple higher than the second frequency of the reflector (scanner). Under the scheme, the three light sources will not be combined in the combiner. The X cube, X plate or prism 400A of the embodiment of FIGS. 5 and 6 will be used to guide the light from three directions to the reflector, respectively, and will be mixture within the eyes by persistence of vision phenomena. The scheme may save the power and the energy it is because that the three different independent illuminations are not turned on all the time and the three color illuminations will not be combined by the combiner. Actually, in the present invention, the combiner is absent.

Please refer to FIG. 7A, it shows the timing corresponding to the color sequence of the present invention, in one image signal frame denoted by S, at least three different color illuminations R, G, B are switched with sequence and irradiate on the reflector. The switching rate of the three different color illuminations R, G, B is tripe to the rate of the image signal frame S. In the case, the signals of the color illuminations R, G, B are not overlap, namely, each color illumination is turned on one by one with ⅓ time of the image signal frame S. After a certain displaying time, each illumination is switched on for only ⅓ of the total displaying time, thereby saving the energy and lasting the life duration of the illuminations. In order to balance between the luminous and power saving, the color control module may control the switching rate as shown in FIG. 7B, in the embodiment, the first color illumination overlaps with the second color illumination with fifty percentages of the total on cycle of each illumination. During the “on” cycle of first color, the second color illumination is also turn on within the later half on-cycle of the first color. Namely, turn-on time of the first color illumination is overlapped with the one of the second color illumination by 50 percentage of the total on-cycle of each lamination to increase the luminous but consuming more power. Similarly, the above scheme may be applied to the second color and third color illumination as well. Under the scheme, only two of the three colors are switched-on within a certain time. Namely, a second color light is not switched on until the later half on-cycle of the first color illumination. When, the first color illumination is off (the half time of one image signal frame; half time of the second color illumination on-cycle), the third color illumination is on. Under the same scheme, the three different illuminations are power on with fifty percentage overlapped time by color sequence to increase the photon number and luminance. At ¾ time of one image signal frame; half on-cycle time of the third color illumination of the third color light source, the second color is off and the first color may be turned on depending on the demand; or the first color is off until next image signal frame S (the control will be easier). The switching rate of the light source is twice higher than the rate of the image signal frame S. FIG. 7C shows that the turn-on overlapped time between two different colors is longer than half cycle of the on-cycle (but not totally overlap) of each light source. In the case, three illuminations may be turned on at the same time. FIG. 7D shows that the turn-on overlapped time between two different colors is shorter than half cycle (fifty percentages) of each light source. In the case, only two illuminations may be turned on at the same time. The turning on time of each light source is longer than FIG. 7A, but shorter than FIG. 7B. Thus, the color control module 100 may control the switching rate and turn-on time to control the overlap status to allow the overlapped time is equal, higher, less than half cycle (fifty parentages) of the turn-on time of each color light (illumination) source to reaching the balance between the luminous and power saving. The present scheme may be used for four color illuminations, the maximum switching rate of the different color illuminations is four times of the rate of the image signal frame S. The image signal is fed into the reflector to control its status.

A multiple rate projector comprises at least three different color illuminations to illuminate a pre-determined light, respectively; a color control module coupled to the at least three different color illuminations to switch the at least three different color illuminations on, respectively to allow turn-on times of two of the at least three different color illuminations are not overlapped, or the turn-on times of the two of the at least three different color illuminations are overlapped with half cycle, longer or short than half cycle of on cycle of each the at least three different color illuminations; and a two-dimension reflector reflects illumination from the at least three different color illuminations to a location. A light guiding device is provided to allow the at least three different color illuminations located three sides of the light guiding device. The light guiding device includes X cube, X plate or prism. The multiple rate projector may be integrated in to a portable device including cellular, computer, notebook, tablet, digital image capturing device, GPS, media player. In another aspect, the multiple rate projector comprises at least three different color illuminations to illuminate a pre-determined light, respectively. A color control module is coupled to the at least three different color illuminations to switch the at least three different color illuminations on; wherein a switching rate of the at least three different color illuminations is multiple time to an image signal frame rate; and a two-dimension reflector reflects illumination from the at least three different color illuminations to a location.

The present invention may saves the power consumption and thermal generated by the light sources due to the illumination is not always on.

As will be understood by persons skilled in the art, the foregoing preferred embodiment of the present invention is illustrative of the present invention rather than limiting the present invention. Having described the invention in connection with a preferred embodiment, modification will now suggest itself to those skilled in the art. Thus, the invention is not to be limited to this embodiment, but rather the invention is intended to cover various modifications and similar arrangements included within the spirit and scope of the appended claims, the scope of which should be accorded the broadest interpretation so as to encompass all such modifications and similar structures. While the preferred embodiment of the invention has been illustrated and described, it will be appreciated that various changes can be made therein without departing from the spirit and scope of the invention.

1. A multiple rate projector comprises:
at least three different color illuminations to illuminate a pre-determined light, respectively;
a color control module coupled to said at least three different color illuminations to switch said at least three different color illuminations, respectively to allow turn-on times of two of said at least three different color illuminations are not overlapped, or said turn-on times of said two of said at least three different color illuminations are overlapped by 50 percentage, longer or short than said 50 percentage; and
a two-dimension reflector reflects illumination from said at least three different color illuminations to a location.

2. The multiple rate projector of claim 1, furthering comprising a light guiding device to allow said at least three different color illuminations located three sides of said light guiding device.

3. The multiple rate projector of claim 2, wherein said light guiding device includes X cube, X plate or prism.

4. The multiple rate projector of claim 1, wherein said at least three different color illuminations include lasers.

5. The multiple rate projector of claim 1, wherein said at least three different color illuminations include LEDs.

6. The multiple rate projector of claim 1, wherein said at least three different color illuminations include OLEDs.

7. The multiple rate projector of claim 1, wherein said multiple rate projector is integrated in to a portable device including cellular, computer, notebook, tablet, digital image capturing device, GPS, media player.

8. A multiple rate projector comprises:
at least three different color illuminations to illuminate a pre-determined light, respectively;
a color control module coupled to said at least three different color illuminations to switch said at least three different color illuminations; wherein a switching rate of said at least three different color illuminations is multiple time to an image signal frame rate; and
a two-dimension reflector reflects illumination from said at least three different color illuminations to a location.

9. The multiple rate projector of claim 8, furthering comprising light guiding device to allow said at least three different color illuminations located three sides of said light guiding device.

10. The multiple rate projector of claim 9, wherein said light guiding device includes X cube, X plate or prism.

11. The multiple rate projector of claim 8, wherein said red, green and blue illuminations include lasers.

12. The multiple rate projector of claim 8, wherein said red, green and blue illuminations include LEDs.

13. The multiple rate projector of claim 8, wherein said red, green and blue illuminations include OLEDs.

14. The multiple rate projector of claim 8, wherein said multiple rate projector is integrated in to a portable device including cellular, computer, notebook, tablet, digital image capturing device, GPS, media player.
